(19) United States
(12) Patent Application Publication
(10) Pub. No.: US 2010/0258552 A1
(43) Pub. Date: Oct. 14, 2010

(54) Polytetrafluoroethylene Heating Product and Its Manufacturing Method

(75) Inventors: Yonggao Zhao, Wenzhou (CN); Wei Zhao, Wenzhou (CN); Guolong Chen, Wenzhou (CN)

Correspondence Address: GLOBAL IP SERVICES, 7285 W. Eagle Court, Winton, CA, 95388, US

(73) Assignee: Yonggao Zhao, Wenzhou (CN)

(21) Appl. No.: 12/042,331

(22) Filed: Mar. 5, 2008

(30) Foreign Application Priority Data
Sep. 21, 2007 (CN) 200710071378.0

(51) Int. Cl. H05B 3/02; B29C 71/02

(52) U.S. Cl. 219/546; 156/193

(57) ABSTRACT

The present invention relates to a polytetrafluoroethylene (hereinafter referred to as PTFE) heating product, the technical solution of which includes embedding at least one piece of electrical heating element inside a PTFE substrate with the electrical heating element wiring terminal(s) exposed out of the substrate for connecting an external power source to energize the heating product. Depending on varied purposes, the PTFE heating product can be manufactured into the cylindrical type, which is used in cylindrical apparatuses such as tank reactors, towers, storage tanks, pipes etc. in the chemical industry, or the plate type, which is used in square-type tanks (as equipment) and as domestic heating radiators, or other special types. The present invention also involves the manufacturing methods and installation of the related apparatuses of said PTFE heating product.

### CROSS REFERENCE TO RELATED PATENT APPLICATION

This application claims the priority of the Chinese patent application No. 200710071378.0 with filing date of Sep. 21, 2007, which application is incorporated herein by reference.

### FIELD OF THE INVENTION

The present invention relates to a heating product, in particular a polytetrafluoroethylene heating product and its manufacturing method.

### BACKGROUND OF THE INVENTION

In chemical production and daily life, there is a frequent need of heating certain substances for a particular desired purpose, as in chemical production certain materials need to be heated in a tank reactor to such temperature as required by the reaction to obtain a new substance.

Currently two methods for heating in tank reactors are available. One is to use a jacket around the outside wall to heat the material inside the tank reactor and the other is to place a coil heat exchanger into the medium inside the tank reactor to heat the medium; heat transfer oil (heated by electrical heating rod) or high-pressure steam is used as heating agent (a heat carrier) inside said jacket or coil tube. In case of corrosive medium, the inner wall of the reactor (or outer wall of the coil) needs to be lined or covered with corrosion-resistant materials such as enamel, glass enamel, plastic, graphite or even high-grade alloy.

Nowadays the corrosion-resistant tank reactor, which is widely lined with polytetrafluoroethylene (hereinafter referred to as PTFE), so called King of Plastic or a top-grade lining material, has the following defects: high heat transfer resistance, low transfer speed and efficiency, and large temperature difference (30-50° C. in general) between the heating agent and medium inside the tank reactor. As a result, the medium inside the tank reactor can hardly be heated to 200° C. (leaving many kinds of important production impossible) and the thermal efficiency (utilization rate) is very low, which is generally 60-70%. And in cases of heating with a coil heat exchanger. Besides the above-mentioned defects, tank reactors have to be massive, heavy, and therefore inconvenient for installation. In daily life, the simplest and widely used glass-tube electric heaters for boiling water in thermos bottles are frequently and easily damaged owing to dried bottles or collision, which causes a lot of trouble for their users.

Absolutely clean and toxicity-free, PTFE is presently one of the best corrosion-resistant materials in the world. PTFE pipes and tank reactors, towers, tank containers, etc. lined with PTFE are widely used in the chemical industry and food processing. The said PTFE products will become ideal heaters if they have a heating function.

### SUMMARY OF THE INVENTION

According to the present invention, the solution to the above technological problems is to provide a PTFE heating product with a heating function.

To solve the said technical problem, the present invention adopts the method of embedding at least one piece of electrical heating element in a PTFE substrate, whose electrical terminal connected with power supply is exposed out of the PTFE substrate (with two wiring terminals for power supply exposed outside of the PTFE substrate) for connecting an external power source to energize the electric heater (the PTFE substrate).

According to different purposes, the PTFE heating product of the present invention can be made into the cylindrical type or plate-type or other special type electric heaters for industrial production or home use. Compared with conventional heating elements or heaters, the present invention has the following advantageous features: low thermal resistance, less heating time and small temperature difference (merely 10-20° C. in general) between the heating agent and the reactant; high thermal efficiency (utilization rate) (85-95% in general); enabling materials to be heated to over 200° C. to react at a high temperature; resistance to high-temperature and strongly corrosive medium; clean and toxicity-free, no resultant corrosive products and non-adherence to any other substance; with light body, easy installation and use, and durability with a long service life.

The PTFE heating product can be used for a plurality of different purposes, and putting in mass production and wide application, will replace and upgrade conventional electric heaters already in use for a long time, which not only enables a plurality of new-technology based and high-return projects involving strongly-corrosive reaction at a high temperature to be successfully put into operation, which is impossible before, but also existing enterprises' related production can be much accelerated with productive value significantly increased and huge economic benefits obtained. Besides, what is more important is that said PTFE heating product has a high heat utilization rate of 85-95% so that a great deal of energy (electricity) can be economized, which is of significance to China.

For a better understanding of the present invention, reference is made to the accompanying drawings and descriptive matter hereinafter in which a preferred embodiment of the invention is further illustrated.

### BRIEF DESCRIPTION OF THE DRAWINGS

In the drawings:

FIG. 1 is a schematic view of the first preferred embodiment of the PTFE heating product of the present invention;

FIG. 2 is a schematic view of the second preferred embodiment of the PTFE heating product of the present invention;

FIG. 3 is a schematic view of the third preferred embodiment of the PTFE heating product of the present invention;

FIG. 4 is a schematic view of the fourth preferred embodiment the PTFE heating product of the present invention;

FIG. 5 is a schematic view of installation of the tank reactor shown in the first preferred embodiment of the PTFE heating product of the present invention;

FIG. 6 is a schematic view of alternative installation of the tank reactor shown in the first preferred embodiment of the PTFE heating product of the present invention;

FIG. 7 is a schematic view of installation of a tank reactor of the second preferred embodiment of the PTFE heating product of the present invention;

FIG. 8 is a schematic view of installation of a tank reactor for the PTFE heating product with a metal mesh of the present invention;

FIG. 9 is a structural view of the enlarged Part I in FIG.8.

### DETAIL DESCRIPTION OF THE INVENTION

In structure, the PTFE heating product can be of cylindrical or plate type. The cylindrical-type PTFE heating product can be used in such round equipment as tank reactors, towers, tank containers, pipes, etc. for production in the chemical industry and the plate-type PTFE heating product be used in square tanks (as equipment) and the heating radiators and the alike for home use. Out of different purposes, the PTFE heating product can be single-functional (for heating) or bi-functional (for both corrosion resistance and heating). Mostly used as equipment linings, the bi-functional PTFE heating product, apart from having electrical heating elements in its PTFE layers, can be laid around its PTFE substrate a metal mesh which is covered with another PTFE layer. By applying the metal mesh, the thermal expansion and cold contraction of the PTFE linings can be reduced. Further description for the embodiment will be made with reference to the accompanying drawings.

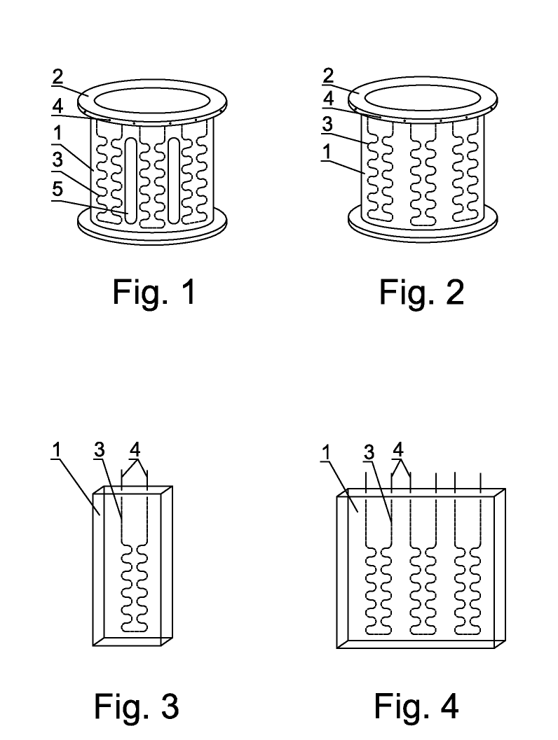

The preferred embodiment shown in FIG. 1 and FIG. 2 is a cylindrical-type PTFE heating product. The PTFE substrate 1 is in cylindrical shape with a thin wall. Inside PTFE substrate 1 there provide sets of electrical heating elements 3 connected in parallel with the number of the sets determined by the power of a heater. The wiring terminal 4 of the electrical heating elements 3 exposed outside the PTFE substrate is connected to an external power supply.

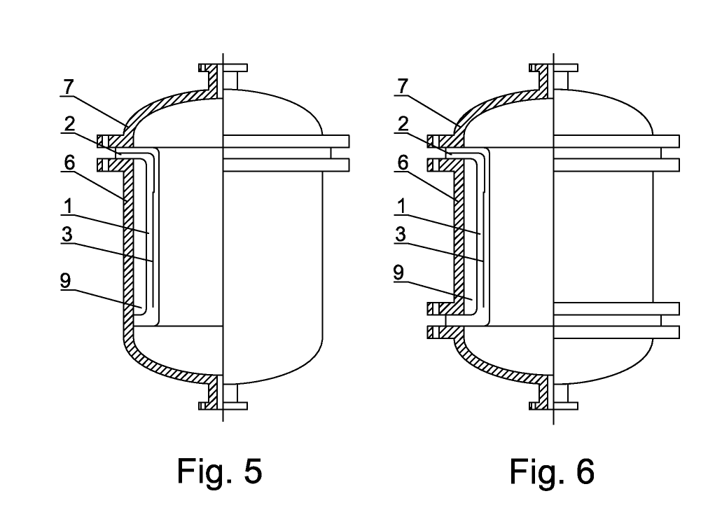

The preferred embodiments shown in FIG. 1, FIG. 5 and FIG. 6 are a single-functional cylindrical-type PTFE heating product. A plurality of through slots 5 are existed on the surface of the cylindrical-type polytetrafluoroethylene substrate and between each piece of electrical heating element 3 to facilitate easy flow of the medium and heating on both inner and outer sides of the PTFE heating product. Thus better heating effect, less heating time and higher thermal efficiency up to 90-95% obtained. The said PTFE heating product is suitable for heating medium in such equipment as common tank reactors, towers or tank containers. The turned-over edge 2 of said heating product is clamped between the flange of the cylindrical body 6 and that of the gland 7. An interstice 9, generally 20-40 mm is required between the cylinder 6 and the PTFE heating product.

As shown in FIG. 5, for installation and use of such bottom-integrated equipment as common enamel tanks, turned-over edges 2 are clamped between the flange of cylinder 6 and the flange of gland 7, and it is enough to make the lower turned-over edge to such a narrow extent that it can just contact the inner wall of the cylindrical body. For installation and use of the equipment (such as a tank reactor) whose top and bottom are connected with flanges as shown in FIG. 6, the upper and lower turned- over edges 2 of the PTFE heating product are installed respectively between upper and lower flanges of cylinder 6 and gland 7. After the above installation, the wiring terminals 4 of the electrical heating elements on the end surface of the upper flange are connected to a power supply line to make the PTFE heating product ready for use.

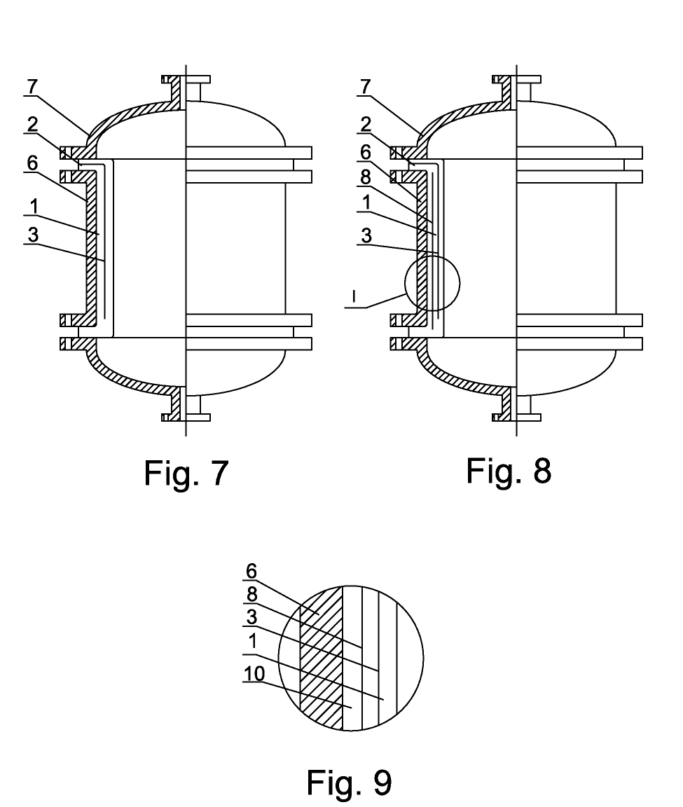

A PTFE heating product with the dual functions of corrosion resistance and heating according to the embodiment shown in FIG. 2, FIG. 7 and FIG. 8 is also used as a corrosion-resistant lining to equipment housing. The outer diameter of said PTFE heating product should be identical to the inner one of the equipment housing. In comparison with the single-functional PTFE heating product shown in FIG. 1, no through slot is cut on the substrate of said bi-functional product. In case of a PTFE heating product also used as a corrosion-resistant lining of equipment, around its PTFE substrate 1 is laid a metal mesh 8 which is covered with another PTFE layer 10, the purpose of which is to reduce the thermal expansion and cold contraction of the corrosion-resistant PTFE lining.

The production methods of the PTFE heating product, with that of single-functional and bi-functional cylindrical-type as examples, are illustrated as follows:

1. Wind PTFE straps, 0.1 mm thick and 20-50 mm wide, in an interleaving and overlapping manner around a particular (in diameter and length) stainless steel clamping fixture to half of a desired thickness (3-6 mm), and then lay finished electrical heating elements of required number evenly on these PTFE straps. Finally wind PTFE straps again upon those electrical heating elements till the other half of the desired thickness is reached.

2. Wind tightly upon PTFE straps multiple layers of glass filament straps (approximately 0.1-0.2 mm thick and 20 mm wide) in the same manner as PTFE straps are wound. The PTFE straps shall be completely wrapped inside the glass filament straps with no an of the PTFE straps allowed to be exposed, and both ends of the glass filament straps shall be tightly tied;

3. Place the semi finished article that has been wound according to the above Steps 1 and 2 in a heating furnace for shaping by sintering in the following procedures: Raise slowly the temperature inside the furnace to 380° C. and keep the semi finished article at the temperature for 30 minutes. Then reduce slowly the temperature to have the semi finished article cool down and when it comes to less than 50° C., open the furnace door and unload the semi finished article;

4. Remove all the glass filament straps from the semi finished article and demould it so that a cylindrical-type (referring to the cylindrical body of a tank reactor) PTFE heating product with a turned-over edge at the both ends of the product is obtained (as shown in FIG. 2);

5. Cut multiple through slots on the PTFE surface between the electrical heating elements of the PTFE heating product mentioned in above Step 4 to form a finished PTFE heating product with through slots (as shown in FIG. 1).

For forming a bi-functional cylindrical-type PTFE heating product with a metal mesh, PTFE straps are wound in three times: first 40% of all the PTFE straps for the winding operation are wound on the clamping fixture and the electrical heating elements 3 laid on the laid PTFE straps; then the other 30% of the PTFE straps are wound on the applied electrical heating elements 3 and a metal mesh is placed on the newly applied PTFE straps; finally the remaining 30% of PTFE straps are wound on the newly laid metal mesh, after which glass filament straps are wound on the PTFE straps applied for the last time.

For applying electrical heating elements inside the PTFE lining upon a pipe wall, besides the above-mentioned method, an alternative method can also be employed to sandwich electrical heating filaments in the shape of a spring between PTFE layers: after half of the PTFE straps to be applied are wound around a clamping fixture, electrical heating filaments of a desired length are wound on the freshly applied PTFE straps; the remaining half PTFE straps are wound on the applied electrical heating filaments; glass filament straps are wound on the applied PTFE straps; the resultant semi finished article is solidified by sintering and then demolded. The finished semi finished article is lined around a steel pipe with the PTFE edge over turned at both ends of the pipe.

The preferred embodiment schematically shown in FIG. 3 and FIG. 4 is a plate-type PTFE heating product. The PTFE substrate 1 is of plate type, in which is placed at least one set of electrical heating elements 3 whose wiring terminal 4 is exposed outside the PTFE substrate 1 and connected with power supply. Plate-type PTFE products can contain a single or multiple electrical heating element(s). The plate-type PTFE heating product schematically shown in FIG. 3, used for boiling water in small containers such as thermos bottles or for other purposes, has only one electrical heating element 3. The plate-type PTFE product schematically shown in FIG. 4 has multiple electrical heating elements and in the PTFE substrate 1 are placed a number of sets of electrical heating elements 3 connected in parallel, used for heating a medium in square tanks. The used number of the electrical heating elements 3 depends on a required power of a heating product. Multiple PTFE heating plates, each containing multiple electrical heating elements, can be connected in parallel for heating in large equipment.

Generally, plate-type PTFE heating products can be produced in a method similar to that described in the above step 1-4 for single-functional cylindrical-type PTFE heating products. Specifically, to make a plate-type PTFE heating product with multiple electrical heating elements as shown in FIG. 4, first prepare a cylindrical PTFE heating product without its edges turned over, and then make a cut through the thickness and length of the cylindrical product and press it into a plate; to make a plate-type PTFE heating product with a single electrical heating element as shown in FIG. 3, cut longitudinally into several pieces a prepared cylindrical PTFE heating product without its edges turned over in such a way that only a single electrical heating element is contained within one piece, and then press each of the pieces into a plate. Alternatively, plate-type PTFE heating products can be produced by molding, which involves the following steps:

(1) prepare a set of required male and female steel dies;

(2) load in the female die PTFE powdery material or a PTFE thin plate, then place electrical heating elements on said PTFE powder or PTFE thin plate before placing additional PTFE powdery material or a PTFE thin plate on said electrical heating elements;

(3) Place the male die on the female die and press the dies hard on a press to make the powder compact;

(4) Place the resultant semi finished article in a furnace and heat it to 380° C. and after taking the semi finished article out, have it molded on a press, cooled and demolded to obtain a finished plate-type PTFE heating product.

By taking as example the production of a PTFE product (200 (length)×25 (width)×3 (height) (mm)) with a single electrical heating element, in which 30 g PTFE powdery material is needed, the production method is illustrated as follows:

(1) Prepare a male-female steel die that fits the production of the PTFE heating product of the above-mentioned size;

(2) Load half (15 g) of needed PTFE powdery material to the female die, level the powder, and then gently put an electrical heating element. Add the remaining 15 g powder and gently level it;

(3) Place the male die on the female die and press the dies hard on a press to make the powder compact;

(4) Place the resultant semi finished article in a furnace and heat it to 380° C. and after the semi finished article slightly cools down, remove it from the furnace for demolding so as to obtain a finished plate-type PTFE heating product.

Alternatively, in the above-mentioned method, PTFE powdery material can be replaced with a 1.5 mm thick PTFE thin plate for being loaded in the female die. Place an electrical heating element on the PTFE thin plate, and on the electrical heating element place another 1.5 mm thick PTFE thin plate. Finally add the male die and put the resultant semi finished article inside into a furnace and heat it to 380° C. After the semi finished article is removed from the furnace, have it cooled and remolded to obtain a finished plate-type PTFE heating product.

What is claimed is:

1. A polytetrafluoroethylene heating product including: a polytetrafluoroethylene substrate; at least a piece of electrical heating element being embedded in said polytetrafluoroethylene substrate with two wiring terminals for power supply exposed outside of said polytetrafluoroethylene substrate.

2. The polytetrafluoroethylene heating product in accordance with claim 1, wherein said polytetrafluoroethylene substrate is of cylindrical type.

3. The polytetrafluoroethylene heating product in accordance with claim 1, wherein said polytetrafluoroethylene substrate is of plate type.

4. The polytetrafluoroethylene heating product in accordance with claim 2, wherein a plurality of through slots are existed on the surface of said cylindrical-type polytetrafluoroethylene substrate and between each said piece of electrical heating element.

5. The polytetrafluoroethylene heating product in accordance with claim 2, wherein a metal mesh is laid around said polytetrafluoroethylene substrate and then said metal mesh is covered with another polytetrafluoroethylene layer.

6. An apparatus with a cylindrical body comprising: the polytetrafluoroethylene heating product of claim 2 being installed within said cylindrical body, turned-over edges of said polytetrafluoroethylene heating product being clamped between a flange of the cylindrical body and a flange of gland.

7. An apparatus with a cylindrical body comprising the polytetrafluoroethylene heating product of claim 4 is installed within said cylindrical body, turned-over edges of said polytetrafluoroethylene heating product being clamped between a flange of said cylindrical body and a flange of gland, and an interstice being provided between said cylindrical body and said polytetrafluoroethylene heating product.

8. A manufacturing method for the polytetrafluoroethylene heating product of claim 2 comprising:
(1) Wind polytetrafluoroethylene straps in an interleaving and overlapping manner around a particular stainless steel clamping fixture to half of a desired thickness, then evenly place said electrical heating elements of required number on said polytetrafluoroethylene straps, finally wind polytetrafluoroethylene straps upon those electrical heating elements to the desired thickness;
(2) wind upon the polytetrafluoroethylene straps multiple layers of glass filament straps in the same way as polytetrafluoroethylene straps are wound as recited in the first Step, all the polytetrafluoroethylene straps being sealed inside said glass filament straps without any of them exposed and the both ends of said glass filament straps being tightly tied;
(3) place the semi finished article got from the second step into a heating furnace for solidifying by sintering in the following procedures: Raise slowly the temperature inside the furnace to 380° C. and keep 380° C. for 30 minutes, then reduce slowly said temperature to less than 50° C., open the door of said heating furnace and unload the semi finished article got from third step;
(4) Clear all the residual glass filament straps from the outer surface of said semi finished article got from third step, have the cleared semi finished article got from third step demolded and both ends of said cleared semi finished article over turned to obtain a cylindrical-type polytetrafluoroethylene heating product.

9. The manufacturing method of claim 8, further comprising:
(5) Cut a multiple of through slots on the polytetrafluoroethylene layers between each of the electrical heating elements.

10. A manufacturing method for the polytetrafluoroethylene heating product of claim 3 comprising the following procedures:
(1) Fabricate a set of male and female steel dies that meet the requirements of the manufacture of said polytetrafluoroethylene heating product;
(2) Load polytetrafluoroethylene powdery material or a thin polytetrafluoroethylene plate into said female die, put electrical heating elements on said loaded polytetrafluoroethylene powdery material or said thin polytetrafluoroethylene plate, and then place another polytetrafluoroethylene powdery material or thin polytetrafluoroethylene plate onto said electrical heating elements;
(3) Place said male die onto said powder or said thin polytetrafluoroethylene plate and press said dies on a press to get a semi finished article;
(4) Place said semi finished article in a heating furnace and heat said semi finished article to 380° C.; move said semi finished article to molding again on a press, cooling and demolding so as to obtain a finished plate-type polytetrafluoroethylene heating product.
